(19) United States
(12) Patent Application Publication
(10) Pub. No.: US 2009/0193346 A1
(43) Pub. Date: Jul. 30, 2009

(54) APPARATUS AND METHOD TO IMPROVE A GRAPHICAL USER INTERFACE

(75) Inventors: MATTHEW CHARLES COMPTON, TUCSON, AZ (US); MARILYNN GLORIA FRANCO, TUCSON, AZ (US); MICHAEL R. MALETICH, TUCSON, AZ (US); RAJENDRAN SUBRAMANIAM, TUCSON, AZ (US)

Correspondence Address: DALE F. REGELMAN;QUARLES & BRADY, LLP, ONE SOUTH CHURCH AVENUE, STE. 1700, TUCSON, AZ, 85701-1621, US

(73) Assignee: INTERNATIONAL BUSINESS MACHINES CORPORATION, ARMONK, NY (US)

(21) Appl. No.: 12/022,827

(22) Filed: Jan. 30, 2008

(51) Int. Cl. G06F 3/00

(52) U.S. Cl. 715/762

(57) ABSTRACT

A method to improve a graphical user interface, wherein the method displays a GUI on a user computing device, and maintains a keystroke log on that user computing device, wherein the GUI comprises a first plurality of interactable graphical objects. The method activates one or more of the first interactable graphical objects, and encodes in the keystroke log each interactable graphical object activation. The method further performs a keystroke log analysis, and, based upon the keystroke log analysis, creates an improved GUI encoding a second plurality of interactable graphical objects.

### FIELD OF THE INVENTION

This invention relates to an apparatus and method to improve a graphical user interface.

### BACKGROUND OF THE INVENTION

A graphical user interface (“GUI”) facilitates interaction with a computing device. GUIs comprise interactable graphical objects, sometimes referred to as widgets, in combination with text, represent information and actions available to a user. The actions are usually initiated through direct manipulation of the interactable graphical elements.

Graphical user interfaces often include a pointer that comprises a symbol that appears on a display screen and is used to select objects and commands, a pointing device comprising for example a mouse or trackball, that enables movement of the pointer, graphical interactable objects that represent commands, files, or windows. By moving the pointer to, and activating, a interactable graphical object, a user can execute a command or open a window.

### SUMMARY OF THE INVENTION

The invention comprises a method to improve a graphical user interface. The method supplies a first code base encoding a first plurality of interactable graphical objects, wherein a first graphical user interface (“GUI”) is generated and visually displayed when the code base is executed on a computing device interconnected to a visual display device, wherein the first GUI comprises the first plurality of interactable graphical objects and a pointer comprising a symbol, wherein a pointing device in communication with the computing device enables movement of the pointer such that by moving the pointer to, and activating, an interactable graphical object, a command can be executed or a new window can be opened.

The method further executes the first code base on a user computing device, and maintains a keystroke log on that user computing device. The method activates one or more of the first interactable graphical objects, and encodes in the keystroke log each interactable graphical object activation. The method further performs a keystroke log analysis, and creates a second code base encoding a second plurality of interactable graphical objects based upon the keystroke log analysis.

### BRIEF DESCRIPTION OF THE DRAWINGS

The invention will be better understood by reading the following detailed description taken in conjunction with the drawings in which like reference designators are used to designate like elements, and in which:

FIG. 1 illustrates one embodiment of a user computing device comprising a computer readable medium comprising a first code base which encodes a first graphical user interface;

FIG. 2A illustrates the user computing device of FIG. 1 in communication with a first embodiment of Applicants' data storage library;

FIG. 2B illustrates a second embodiment of Applicants' data storage library wherein the functions of the computing device of FIG. 1 are incorporated into a library manager;

FIG. 3 illustrates one embodiment of Applicants' data processing system wherein Applicants' data storage library is in communication with a service center;

FIG. 4 illustrates a second embodiment of Applicants' data processing system wherein a plurality of data storage libraries are in communication with a system console which is in communication with a service center;

FIG. 5 is a flow chart summarizing the initial steps of Applicants' method;

FIG. 6 is a flow chart summarizing certain additional steps of Applicants' method; and

FIG. 7 is a flow chart summarizing certain additional steps of Applicants' method.

### DETAILED DESCRIPTION OF THE PREFERRED EMBODIMENTS

This invention is described in preferred embodiments in the following description with reference to the figures (“FIGS.”), in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Graphical user interface (“GUI”) design is an important adjunct to application programming. A GUI enhances the usability of the underlying logical design of a stored program. In certain embodiments, Applicants' Code Base is encoded in memory disposed in a computing device in communication with a visual display device. When Applicants' Code Base is executed, Applicants' GUI is generated and visually displayed on the visual displace device. As a general matter, Applicants' Code Base can be stored in, and executed by, a computing device such as a mainframe computer, personal computer, workstation, and combinations thereof, wherein that computing device comprises, inter alia, an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald).

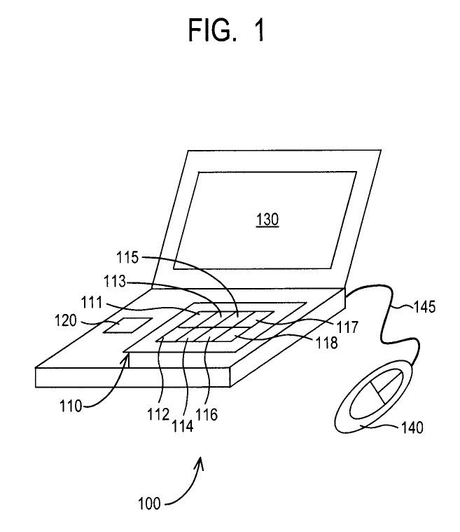

For example and referring now to FIG. 1, computing device 100 comprises memory 110, processor 120, operating system 111, code base 112, keystroke log 113, database 114, instructions 115, application program 116, browser 117, communication program 118. In the illustrated embodiment of FIG. 1, operating system 111, code base 112, keystroke log 113, database 114, instructions 115, application program 116, browser 117, and communication program 118, are written to memory 110.

In the illustrated embodiment of FIG. 1, computing device 100 comprises visual display device 130. In other embodiments, visual display device is a separate assembly that is in communication with computing device 100.

In the illustrated embodiment of FIG. 1, pointing device 140 is interconnected with computing device via cable 145. In other embodiments, pointing device 140 is in wireless communication with computing device 100.

Code base 112 encodes Applicants' GUI. When code base 112 is executed, Applicants'GUI is generated. In certain embodiments, code base 112 is executed using browser program 117.

In the illustrated embodiment of FIG. 1, Applicants'GUI is displayed on display device 130. In certain embodiments, Applicants' GUI enhances the usability of an underlying logical design of an application program 116, wherein that application program 116 is used to operate, access, and/or manage, a data storage library. By “data storage library,” Applicants mean a plurality of data storage devices in combination with a library manager and one or more interfaces to one or more host computers. By “data storage device,” Applicants mean a data storage medium in combination with hardware, firmware, and software, needed to write information to, and read information from, that data storage medium, wherein the data storage medium comprises a magnetic data storage medium, an optical data storage medium, an electronic data storage medium, a holographic data storage medium, and combinations thereof.

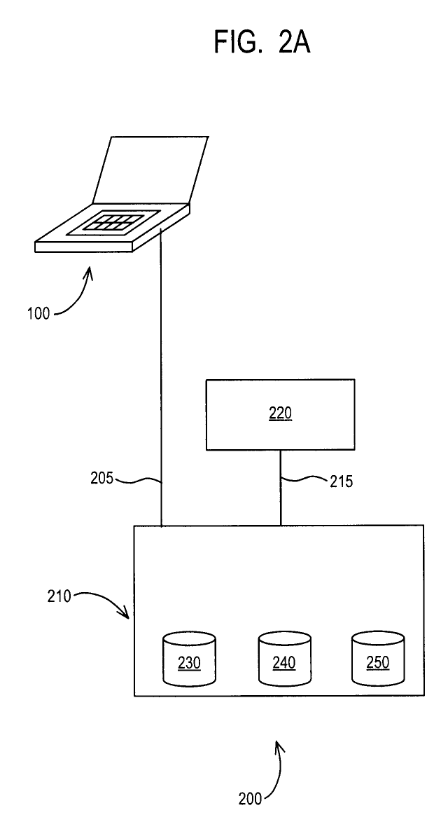

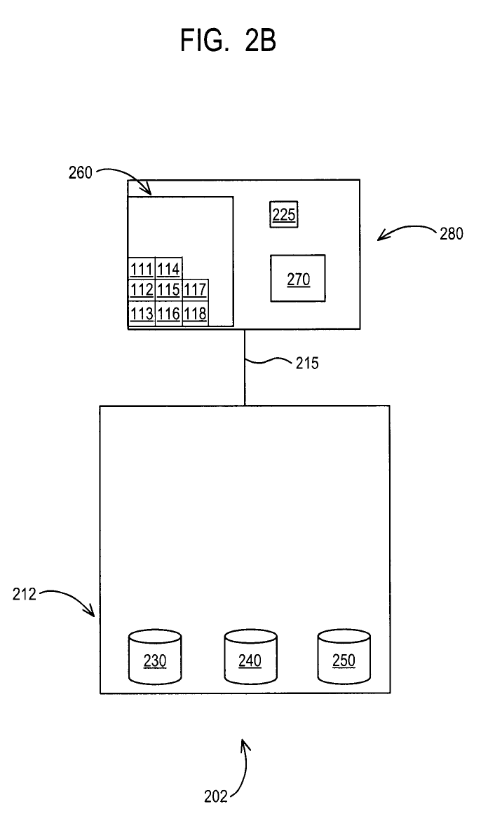

For example and referring now to FIG. 2A, data storage system 200 comprises computing device 100 in communication with data storage library 210. Data storage library 210 comprises library manager 220, and data storage devices 230, 240, and 250.

As those skilled in the art will appreciate, there are various elements not illustrated in data storage library 210, such as and without one or more robotic accessors used to transport portable data storage media to and from a plurality of data storage devices, one or more direct access storage devices (“DASDs”), one or more host adapters, one or more storage device adapters, and the like. In the illustrated embodiment of FIG. 2A, data storage library 210 comprises three data storage devices. In other embodiments, Applicants' data storage library comprises fewer than three data storage devices. In other embodiments, Applicants' data storage library comprises more than three data storage devices. In certain embodiments, Applicants' data storage library comprises a plurality of data storage devices configured to comprise one or more redundant arrays of independent disks (“RAID”), and to utilize one or more RAID data storage protocols.

In the illustrated embodiment of FIG. 2A, computing device 100 communicates with data storage devices 230, 240, and 250, via communication link 205, and library manager communicates with data storage devices 230, 240, and 250, via communication link 215. In certain embodiments, communication links 205 and 215 may utilize any sort of I/O protocol, including without limitation, ESCON, FICON, a fibre channel loop, SCSI (Small Computer System Interface), iSCSI (Internet SCSI), SAS (Serial Attach SCSI), Fibre Channel, SCSI over Fibre Channel, Ethernet, Fibre Channel over Ethernet, Infiniband, and SATA (Serial ATA).

In certain embodiments, Applicants' library manager comprises the elements of computing device 100. For example in the illustrated embodiment of FIG. 2B, Applicants' data storage system 202 comprises data storage library 212 which comprises library manager 280. In the illustrated embodiment of FIG. 2B, library manager 280 comprises processor 225 and memory 260, wherein operating system 111, code base 112, keystroke log 113 encoding, database 114, instructions 115, and application program 116, are written to memory 260. In the illustrated embodiment of FIG. 2B, library manager 280 further comprises visual display device 270.

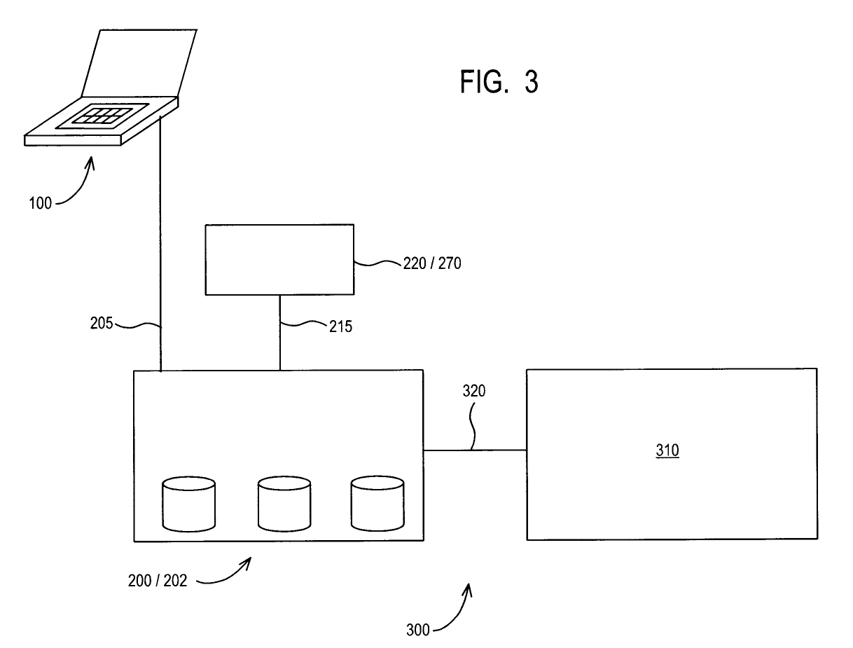

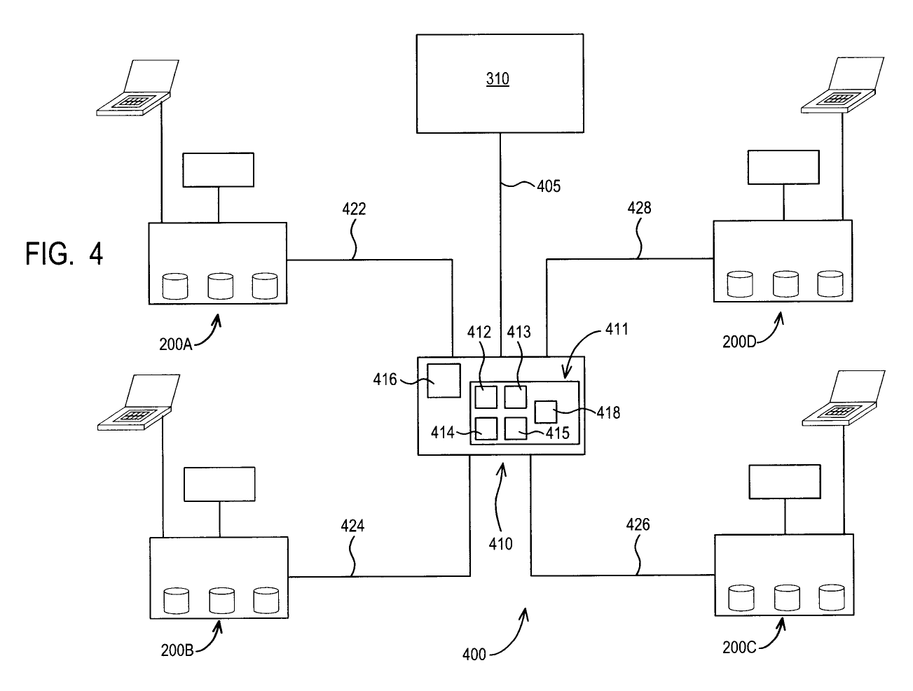

In certain embodiments, Applicants' data storage system is in communication with a service center. In the illustrated embodiment of FIG. 3, Applicants' data processing system 300 comprises data storage system 200, or data storage system 202, in combination with service center 310 (FIGS. 3, 4) via communication link 320. Communication link 320 may utilize any sort of I/O protocol, including without limitation, ESCON, FICON, TCP/IP, a fibre channel loop, SCSI (Small Computer System Interface), iSCSI (Internet SCSI), SAS (Serial Attach SCSI), Fibre Channel, SCSI over Fibre Channel, Ethernet, Fibre Channel over Ethernet, Infiniband, and SATA (Serial ATA).

In embodiments wherein Applicants' data processing system 300 comprises data storage system 200 (FIG. 2A), service center 310 can download keystroke log 113 from computing device 100 using communication links 205 (FIG. 2A) and 320. In embodiments wherein Applicants' data processing system 300 comprises data storage system 202 (FIG. 2B), service center 310 (FIGS. 3, 4) can download keystroke log 113 from library manager 270 using communication link 215 (FIGS. 2A, 2B) and 320.

In certain embodiments, Applicants' data processing system comprises a plurality of data storage systems in communication with a system console which is in communication with a service center. Referring now to FIG. 4, Applicants' data processing system 400 comprises data storage systems 200A, 200B, 200C, and 200D, in communication with system console 410 which is in communication with service center 310 (FIGS. 3, 4).

System console 410 communicates with data storage systems 200A, 200B, 200C, and 200D, via communication links 422, 424, 426, and 428, respectively. System console 410 communicates with service center 310 via communication link 405. Communication links 405, 422, 424, 426, and 428, may utilize any sort of I/O protocol, including without limitation, ESCON, FICON, TCP/IP, a fibre channel loop, SCSI (Small Computer System Interface), iSCSI (Internet SCSI), SAS (Serial Attach SCSI), Fibre Channel, SCSI over Fibre Channel, Ethernet, Fibre Channel over Ethernet, Infiniband, and SATA (Serial ATA).

In the illustrated embodiment of FIG. 4, system console 410 comprises processor 416 and memory 411. Microcode/operating system 418 is encoded in memory 411. Processor 416 utilizes microcode/operating system 418 to operate system console 410.

Further in the illustrated embodiment of FIG. 4, downloaded keystroke logs 412, 413, 414, and 415, are encoded in memory 411. Processor 416, utilizing microcode/operating system 418, can download a first keystroke log from data storage system 200A and store that downloaded keystroke log as downloaded keystroke log 412. Similarly, processor 416, utilizing microcode/operating system 418, can download a second keystroke log from data storage system 200B, a third keystroke log from data storage system 200C, and a fourth keystroke log from data storage system 200D, and store those downloaded keystroke logs as downloaded keystroke logs 413, 414, and 415, respectively. At pre-determined intervals, or in response to detecting an error in one or more interconnected data storage systems, system console 410 provides to service center 310 (FIGS. 3, 4) one or more of downloaded keystroke logs 412, 413, 414, and 415.

In certain embodiments, system console 410 comprises an IBM TS3000 SYSTEM CONSOLE. In the illustrated embodiment of FIG. 1, system console 410 communicates with 4 data storage systems. In other embodiments, system console 410 communicates with more than 4 data storage systems. In yet other embodiments, system console 410 communicates with fewer than 4 data storage systems. In the illustrated embodiment of FIG. 1, system console 410 communicates with one support center. In other embodiments, system console 410 communicates with more than one support center.

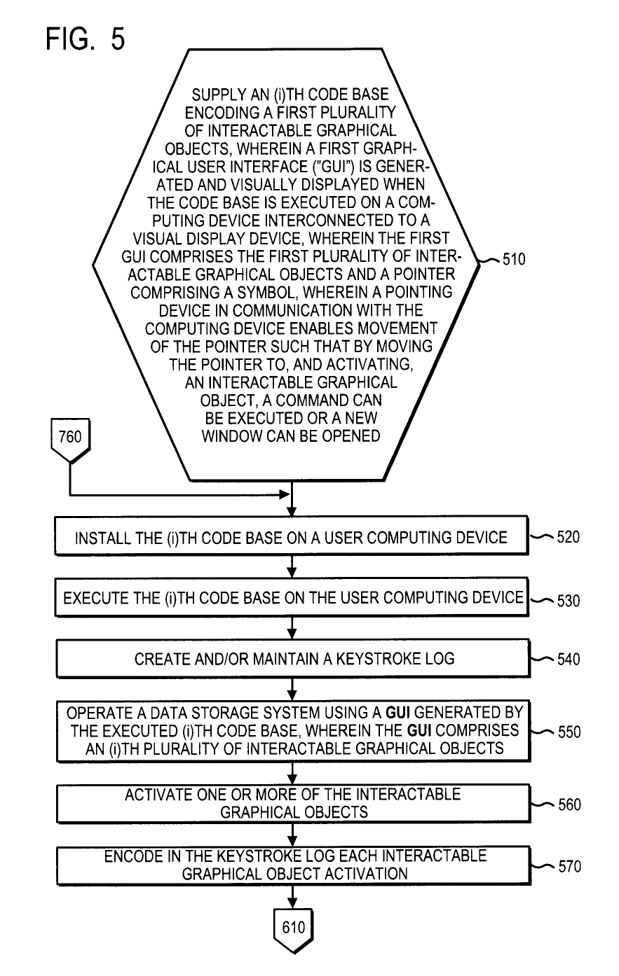

Applicants' invention comprises a method to improve a graphical user interface (“GUI”) encoded by a code base based upon the experiences of one or more actual users. FIG. 5 summarizes the initial steps of Applicants' method. Referring now to FIG. 5, in step 510 the method supplies an (i)th code base encoding an (i)th plurality of interactable graphical objects, wherein an (i)th graphical user interface (“GUI”) is generated and visually displayed when the (i)th code base is executed on a computing device interconnected to a visual display device, wherein that (i)th GUI comprises the (i)th plurality of interactable graphical objects and a pointer comprising a symbol, wherein a pointing device in communication with the computing device enables movement of the pointer such that by moving the pointer to, and activating, an interactable graphical object, a command can be executed or a new window can be opened.

In step 520, the method installs the (i)th code base of step 510 on a user computing device, such as for example computing device 100 (FIG. 1) and/or library manager 280 (FIG. 2B). In certain embodiments, step 520 is performed by the owner and/or operator of the user computing device. In certain embodiments, step 520 is performed by the manufacturer of the user computing device.

In step 530, the method executes the (i) the code base on the computing device of step 520, thereby generating and displaying the (i)th GUI comprising the (i)th plurality of interactable graphical objects. In certain embodiments, the (i)th code base is accessed using browser program 117. In certain embodiments, step 520 is performed by the owner and/or operator of the user computing device. In certain embodiments, step 520 is performed by the owner and/or operator of a data storage system, such as for example and without limitation data storage system 200 (FIG. 2A), or data storage system 202 (FIG. 2B), or data processing system 300 (FIG. 3), or data processing system 400 (FIG. 4).

In step 540, the method creates and/or maintains a keystroke log, such as keystroke log 113. In certain embodiments, step 540 is performed by a browser program, such as browser program 117. In certain embodiments, the keystroke log of step 540 is encoded in a memory, such as memory 110 (FIG. 1) or memory 260 (FIG. 2B), disposed in the user computing device of step 520.

In step 550, the method operates a data storage system using the computing device of step 520 and the GUI of step 530. In certain embodiments, step 550 is performed by the owner and/or operator of a data storage system, such as for example and without limitation data storage system 200 (FIG. 2A), or data storage system 202 (FIG. 2B), or data processing system 300 (FIG. 3), or data processing system 400 (FIG. 4).

In step 560, the method, while operating the data storage system of step 550, activates one or more of the plurality of interactable graphical objects displayed by the GUI of step 530. In certain embodiments, step 560 is performed by the owner and/or operator of a data storage system, such as for example and without limitation data storage system 200 (FIG. 2A), or data storage system 202 (FIG. 2B), or data processing system 300 (FIG. 3), or data processing system 400 (FIG. 4).

In step 570, the method encodes each interactable graphical object activation performed by the user computing device of step 520. In certain embodiments, step 570 is performed by a processor disposed in the user computing device. In certain embodiments, step 570 is performed by browser program 117 comprises JavaScript code, wherein that browser program comprises JavaScript code to detect user actions, such as individual keystrokes.

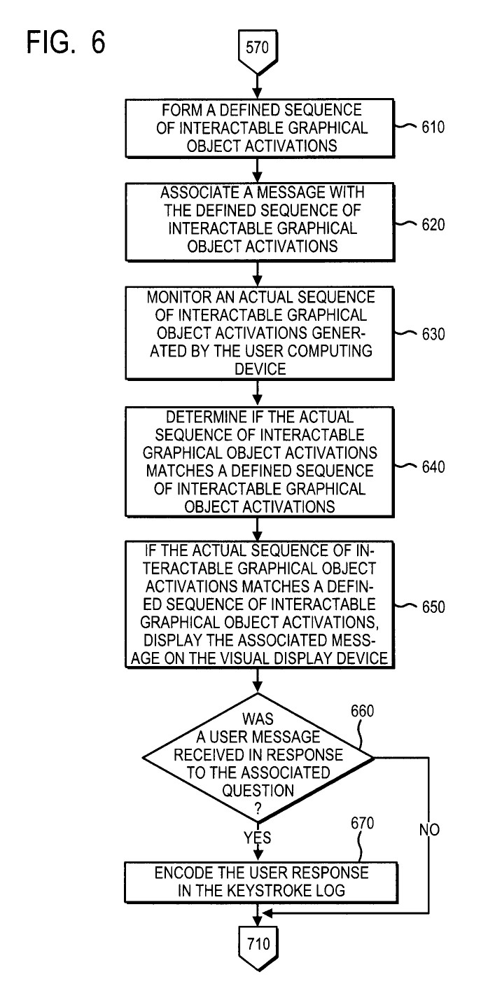

The keystroke log generated by Applicants' method will be later be analyzed by product utilization specialists staffing a product service center. In certain embodiments, Applicants' method includes the steps of FIG. 6, wherein the product utilization specialists predict certain possible errors that may be made by users when operating a data storage system using the GUI of step 530. In certain embodiments, Applicants' method identifies a sequence of interactable graphical object activations made by a user, wherein that sequence may indicate that the user is having trouble achieving the maximum utility of the GUI of step 530.

In step 610 (FIG. 6), the method forms a defined sequence of interactable graphical object activations. In certain embodiments, step 610 comprises forming a plurality of defined sequences of interactable graphical object activations. In certain embodiments, step 610 is performed by the manufacturer of the code base of step 510. In certain embodiments, step 610 is performed by the manufacturer of the user computing device of step 520. In certain embodiments, step 610 is performed by the manufacturer of the data storage system of step 550.

In step 620, the method associates a message with the defined sequence of interactable graphical object activations of step 610. In certain embodiments, step 620 comprises forming a plurality of messages, wherein each message is associated with a different one of a plurality of defined sequences of interactable graphical object activations. In certain embodiments, step 620 is performed by the manufacturer of the code base of step 510. In certain embodiments, step 620 is performed by the manufacturer of the user computing device of step 520. In certain embodiments, step 620 is performed by the manufacturer of the data storage system of step 550.

In certain embodiments, one or more defined sequences of interactable graphical object activations of step 610, and an associated one or more messages of step 620, are encoded in a database, such as database 114 (FIGS. 1, 2B), disposed in a memory device, such as memory device 110 (FIG. 1) or memory device 260 (FIG. 2B), disposed in the user computing device of step 520.

In step 630, the method monitors an actual sequence of interactable graphical object activations generated by the user computing device of step 520 (FIG. 5). In certain embodiments, step 630 is performed by a processor, such as processor 120 (FIG. 1) or processor 225 (FIG. 2B), disposed in the user computing device of step 520 (FIG. 5).

In step 640, the method determines if the actual sequence of interactable graphical object activations of step 630 matches a defined sequence of interactable graphical object activations of step 610. In certain embodiments, step 640 is performed by a processor, such as processor 120 (FIG. 1) or processor 225 (FIG. 2B), disposed in the user computing device of step 520.

In step 650, if the actual sequence of interactable graphical object activations of step 630 matches a defined sequence of interactable graphical object activations of step 610, then the method displays on a visual display device, such as visual display device 130 (FIG. 1) or visual display device 270 (FIG. 2B), a message associated with the matched defined sequence of interactable graphical object activations. In certain embodiments, step 650 is performed by a processor, such as processor 120 (FIG. 1) or processor 225 (FIG. 2B), disposed in the user computing device of step 520.

In step 660, the method determines if a user message was received in response to the visual display of step 650. In certain embodiments, step 660 is performed by a processor, such as processor 120 (FIG. 1) or processor 225 (FIG. 2B), disposed in the user computing device of step 520.

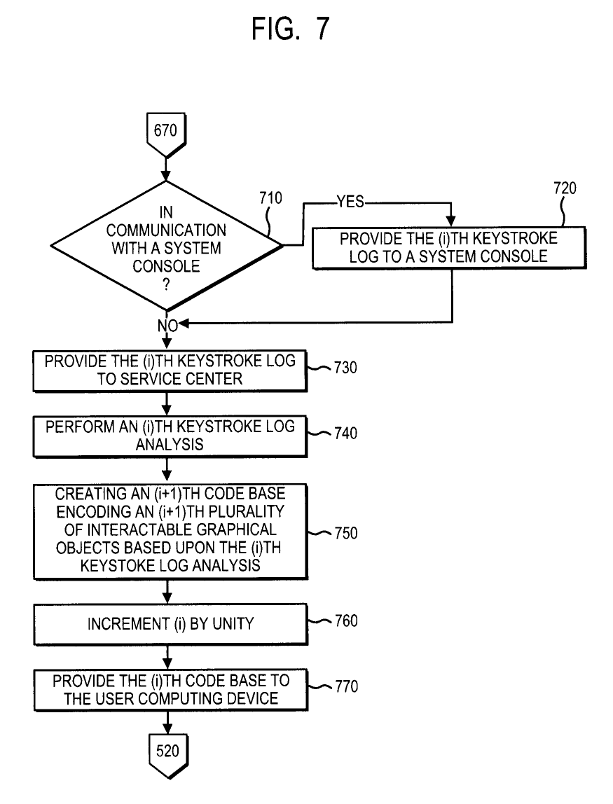

If the method determines in step 660 that a user message was not received in response to the visual display of step 650, then the method transitions from step 660 to step 710 (FIG. 7). If the method determines in step 660 that a user message was received in response to the visual display of step 650, then the method transitions from step 660 to step 670 wherein the method encodes that user response in the keystroke log of step 540. The method transitions from step 670 to step 710 (FIG. 7). In certain embodiments, step 670 is performed by a processor, such as processor 120 (FIG. 1) or processor 225 (FIG. 2B), disposed in the user computing device of step 520.

In step 710, the method determines if the computing device of step 520 is in communication with a system console, such as system console 410 (FIG. 4). In certain embodiments, step 710 is performed by a processor, such as processor 120 (FIG. 1) or processor 225 (FIG. 2B), disposed in the user computing device of step 520.

If the method determines in step 710 that the computing device of step 520 is in communication with a system console, then the method transitions from step 710 to step 720 wherein the method provides the keystroke log of step 520, as supplemented in step 570 (FIG. 5) and/or step 670 (FIG. 6), to the system console. In certain embodiments, step 720 comprises a processor, such as processor 416 (FIG. 4), disposed in the system console querying the computing device of step 520, and downloading the keystroke log. In certain embodiments, in step 720 a browser program, such as browser program 117, utilizing a communication program, such as communication program 118, uploads to the system console the keystroke log of step 520, as supplemented in step 570 (FIG. 5) and/or step 670 (FIG. 6).

In certain embodiments, step 720 is performed by a processor, such as processor 120 (FIG. 1) or processor 225 (FIG. 2B), disposed in the user computing device of step 520. Applicants' method transitions from step 720 to step 730.

In step 730, the method provides the keystroke log of step 520, as supplemented in step 570 (FIG. 5) and/or step 670 (FIG. 6), to a service center, such as service center 310 (FIGS. 3, 4). In certain embodiments, in step 720 a processor, such as processor 120 (FIG. 1) or processor 225 (FIG. 2B), disposed in the computing device of step 520 communicates the (i)th keystroke log to a computing device disposed in the service center.

In certain embodiments, in step 730 a browser program, such as browser program 117, utilizing a communication program, such as communication program 118, uploads to a service center the keystroke log of step 520, as supplemented in step 570 (FIG. 5) and/or step 670 (FIG. 6). In certain embodiments, in step 730 a processor, such as processor 416 (FIG. 4), disposed in a system console 410 (FIG. 4) communicates the (i)th keystroke log to a computing device disposed in the service center.

In step 740, the method analyzes the (i)th keystroke log. In certain embodiments, step 740 is performed by one or more product specialists in the service center.

In step 750, the method, based upon the (i)th keystroke analysis of step 740, revises the (i)th code base to create an (i+1)th code base, wherein that (i+1)th code base encodes an (i+1)th plurality of interactable graphical objects. In certain embodiments, step 740 is performed by one or more product specialists in the service center.

In step 760, the method increments (i) by unity. The method transitions from step 760 to step 520 and continues as described herein.

In step 770, the method provides the (i+1)th code base to the computing device of step 520, wherein that computing device saves the (i+1)th code base in memory, and removes the (i)th code base from memory.

In certain embodiments, individual steps recited in FIGS. 5, and/or FIG. 6, and/or FIG. 7, may be combined, eliminated, or reordered.

In certain embodiments, Applicants' invention includes instructions, such as instructions 115 (FIGS. 1, 2B), residing in computer readable medium, such as for example memory 110 (FIG. 1) or memory 260 (FIG. 2B), wherein those instructions are executed by a processor, such as processor 120 (FIG. 1) or processor 225 (FIG. 2B), respectively, to perform one or more of steps 530, 540, 550, 560, and/or 570, recited in FIG. 5, and/or one or more of steps 610, 620, 630, 640, 650, 660, and/or 670, recited in FIG. 6, and/or one or more of steps 710, 720, and/or 730, recited in FIG. 7.

In other embodiments, Applicants' invention includes instructions residing in any other computer program product, where those instructions are executed by a computer external to, or internal to, computing device 100 (FIG. 1) or library controller 270 (FIG. 2B), to perform one or more of steps 530, 540, 550, 560, and/or 570, recited in FIG. 5, and/or one or more of steps 610, 620, 630, 640, 650, 660, and/or 670, recited in FIG. 6, and/or one or more of steps 710, 720, and/or 730, recited in FIG. 7. In either case, the instructions may be encoded in an information storage medium comprising, for example, a magnetic information storage medium, an optical information storage medium, an electronic information storage medium, and the like. By “electronic storage media,” Applicants mean, for example and without limitation, one or more devices, such as and without limitation, a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to improve a graphical user interface, comprising the steps of:
supplying a first code base encoding a first plurality of interactable graphical objects, wherein a first graphical user interface (“GUI”) is generated and visually displayed when said code base is executed on a computing device interconnected to a visual display device, wherein said first GUI comprises said first plurality of interactable graphical objects and a pointer comprising a symbol, wherein a pointing device in communication with said computing device enables movement of said pointer such that by moving said pointer to, and activating, an interactable graphical object, a command can be executed or a new window can be opened;
executing said first code base on a user computing device;
maintaining a keystroke log on said user computing device;
activating one or more of said first interactable graphical objects;
encoding in said keystroke log each interactable graphical object activation;
performing a keystroke log analysis;
creating, based upon said keystroke log analysis, a second code base encoding a second plurality of interactable graphical objects.

2. The method of claim 1, wherein said user computing device is in communication with a visual display device, further comprising the steps of:
forming a defined sequence of interactable graphical object activations;
associating a message with said defined sequence of interactable graphical object activations;
monitoring an actual sequence of interactable graphical object activations generated by said user computing device;
determining if said actual sequence of interactable graphical object activations matches said defined sequence of interactable graphical object activations;
operative if said actual sequence of interactable graphical object activations matches said defined sequence of interactable graphical object activations, displaying said associated message on said visual display device.

3. The method of claim 2, further comprising the step of encoding said defined sequence of interactable graphical object activations and said associated message in a memory device disposed in said user computing device.

4. The method of claim 2, wherein said user computing device is in communication with a text input device, further comprising the steps of:
receiving a user message responsive to said associated message;
encoding said user message in said keystroke log.

5. The method of claim 1, further comprising the step of supplying a first data storage library comprising a plurality of data storage media, wherein said first data storage library is in communication with said user computing device.

6. The method of claim 5, wherein said user computing device is integral with said first data storage library.

7. The method of claim 5, further comprising the steps of:
supplying a service center in communication with said first data storage library;
providing said keystroke log to said service center.

8. The method of claim 5, wherein said first data storage library downloads said keystroke log from said user computing device.

9. The method of claim 8, further comprising the steps of:
providing a service console in communication with a plurality of data storage libraries, wherein said first data storage library comprises one of said plurality of data storage libraries;
downloading by said service console said keystroke log from said first data storage library;
wherein said service console provides said keystroke log to a service center.

10. The method of claim 9, wherein said service console is in communication with (N) data storage libraries, wherein (N) is greater than 1, further comprising the steps of:
downloading by said service console a different keystroke log from each of the (N) data storage libraries;
providing by said service console (N) keystroke logs to said service center;
wherein said performing a keystroke log analysis step comprises analyzing each of the (N) keystroke logs.

11. An article of manufacture comprising a processor and a computer readable medium, computer readable program code written to said computer readable medium, a keystroke log written to said computer readable program code, and a first code base written to said computer readable medium, wherein said code base encodes a first plurality of interactable graphical objects, wherein a first graphical user interface (“GUI”) is generated and visually displayed when said code base is executed on a computing device interconnected to a visual display device, wherein said first GUI comprises said first plurality of interactable graphical objects and a pointer comprising a symbol, wherein a pointing device in communication with said computing device enables movement of said pointer such that by moving said pointer to, and activating, an interactable graphical object, a command can be executed or a new window can be opened, the computer readable program code comprising a series of computer readable program steps to effect:
executing said first code base;
maintaining a keystroke log on said user computing device;
encoding in said keystroke log each interactable graphical object activation;
providing said keystroke log to a service center.

12. The article of manufacture of claim 11, further comprising a defined sequence of interactable graphical object activations written to said computer readable medium, and a message associated with said defined sequence of interactable graphical object activations written to said computer readable medium, wherein said article of manufacture is in communication with a visual display device, said computer readable program code further comprising a series of computer readable program steps to effect:
monitoring an actual sequence of interactable graphical object activations generated by said user computing device
determining if said actual sequence of interactable graphical object activations matches said defined sequence of interactable graphical object activations;
operative if said actual sequence of interactable graphical object activations matches said defined sequence of interactable graphical object activations, displaying said associated message on said visual display device.

13. The article of manufacture of claim 12, wherein said article of manufacture is in communication with a text input device, said computer readable program code further comprising a series of computer readable program steps to effect:
receiving a user message responsive to said associated message;
encoding said user message in said keystroke log.

14. The article of manufacture of claim 11, further comprising an application program to operate a data storage library comprising a plurality of data storage devices and a library controller, said computer readable program code further comprising a series of computer readable program steps to effect communicating with said data storage library.

15. The article of manufacture of claim 11, said computer readable program code further comprising a series of computer readable program steps to effect:
installing said second code base in said computer readable medium; and
removing said first code base from said computer readable medium.

16. A computer program product encoded in a computer readable medium, wherein a first code base encoding a first plurality of interactable graphical objects is encoded in said computer readable medium, wherein a first graphical user interface (“GUI”) is generated and visually displayed when said code base is executed on a computing device interconnected to a visual display device, wherein said first GUI comprises said first plurality of interactable graphical objects and a pointer comprising a symbol, wherein a pointing device in communication with said computing device enables movement of said pointer such that by moving said pointer to, and activating, an interactable graphical object, a command can be executed or a new window can be opened, comprising:
computer readable program code which causes said programmable computer processor to execute said first code base;
computer readable program code which causes said programmable computer processor to maintain a keystroke log written to said computer readable medium;
computer readable program code which causes said programmable computer processor to encode in said keystroke log each interactable graphical object activation;
computer readable program code which causes said programmable computer processor to receive a second code base encoding a second plurality of interactable graphical objects, wherein said second code base was formed based upon an analysis of said keystroke log;
encode said second code base in said computer readable medium for future use.

17. The computer program product of claim 16, wherein said computer program product further comprises a defined sequence of interactable graphical object activations and a message associated with said defined sequence of interactable graphical object activations, further comprising:
computer readable program code which causes said programmable computer processor to monitor an actual sequence of interactable graphical object activations generated by said computing device
computer readable program code which causes said programmable computer processor to determine if said actual sequence of interactable graphical object activations matches said defined sequence of interactable graphical object activations;
computer readable program code which, when said actual sequence of interactable graphical object activations matches said defined sequence of interactable graphical object activations, causes said programmable computer processor to display said associated message on said visual display device.

18. The computer program product of claim 17, wherein said computing device is in communication with a text input device, further comprising:
computer readable program code which causes said programmable computer processor to receive a user message responsive to said associated message;
computer readable program code which causes said programmable computer processor to encode said user message in said keystroke log.

19. The computer program product of claim 16, further comprising computer readable program code which causes said programmable computer processor to communicate with a data storage library comprising a plurality of data storage devices and a library controller.

20. The computer program product of claim 19, further comprising:
computer readable program code which causes said programmable computer processor to install said second code base in said computer readable medium; and
computer readable program code which causes said programmable computer processor to remove said first code base from said computer readable medium.
